(19) United States
(12) Patent Application Publication
(10) Pub. No.: US 2014/0255577 A1
(43) Pub. Date: Sep. 11, 2014

(54) METHOD AND APPARATUS FOR MATERIAL HANDLING FOR A FOOD PRODUCT IN A HIGH PRESSURE PASTEURIZATION PROCESS

(71) Applicant: Fresher Evolution HPP, L.L.C., Birmingham, MI (US)

(72) Inventors: Gerald Ludwick, Three Rivers, MI (US); Shawn Winkelmann, Elkhart, IN (US)

(21) Appl. No.: 14/346,903

(22) PCT Filed: Sep. 21, 2012
(86) PCT No.: PCT/US2012/056517

§ 371 Date: Mar. 24, 2014

Related U.S. Application Data
(60) Provisional application No. 61/538,226, filed on Sep. 23, 2011.

(51) Int. Cl. A23L 3/015

(52) U.S. Cl. CPC A23L 3/0155
USPC 426/521; 99/467

(57) ABSTRACT

A method and apparatus for material handling of food products in a high pressure pasteurisation process including a pontoon pallet base (141), one or more elongated basket nests (161), and a pontoon pallet separator (180).

### FIELD OF THE INVENTION

The present invention relates to an Improved Method and Apparatus for Material Handling for a Food Product in a High Pressure Pasteurization Process.

### BACKGROUND

Efforts to improve the state of the art in the area of high pressure pasteurization, particularly in the area of efficient handling of product and increased through-put with a high pressure pasteurization (HPP) machine has been receiving ever increasing industry focus over the last few years.

The current state of the art may take many forms, but can generally be characterized as placing food product in a container, placing that container in a HPP machine, and then unloading after the HPP machine has been cycled. It is believed that one focus of the industry has been to provide improvements to the design of the containers, providing a robust basket that is easy to load and unload as well as of such a design that does not damage the pressure chamber of the HPP machine. Another focus is an efficient material handling system that may provide high density storage while maintaining the integrity of the baskets.

Among the literature that may pertain to this technology include the following patent documents; U.S. Pat. No. 7,722,912: U.S. Pat. No. 6,716,464; U.S. Pub. 20040045450; U.S. Pub. 20030089578; U.S. 5,059,392; U.S. Pat. No. 4,773,321 and U.S. Pat. No. 3,622,356 all incorporated herein by reference for all purposes.

### SUMMARY OF THE INVENTION

The present invention is directed to an improved method and apparatus for material handling for a food product in a high pressure pasteurization process. The invention is addressing one or more of the issues/problems discussed above.

In one embodiment the invention is a method comprising: a) placing one or more elongated baskets, the baskets including one or more removable snap-in lids in one or more elongated basket nests of a pontoon pallet base; b) placing and nesting a pontoon pallet separator, the separator including one or more elongated basket nests on each of two opposing sides, over the elongated baskets and the pontoon pallet base; c) placing one or more baskets in the one or more top elongated basket nests on the separator; d) loading product inside the elongated baskets either before or after the placing steps; e) placing a pontoon pallet cap and nesting the cap over the, elongated baskets and the pontoon pallet separator, making a pontoon pallet; f) moving the pontoon pallet to a cell loading station; g) removing the pontoon pallet cap; h) sequentially loading the elongated baskets onto the cell lading station; i) sequentially the elongated baskets into a high pressure pasteurization machine and processing the product in the baskets; j) unloading processed baskets from the high pressure pasteurization machine and moving the processes baskets to a cell unloading station; and k) loading the processed baskets onto an empty pontoon pallet. Preferably the method comprises simultaneously loading new baskets into the high pressure pasteurization machine and unloading processed baskets from the high pressure pasteurization machine, the processed baskets moving to the cell unloading station.

Moreover, the present invention relates to a unique container design and material handling system.

It should be appreciated that the above referenced aspects and examples are non-limiting, as others exist within the present invention as shown and described herein.

### DESCRIPTION OF THE DRAWINGS

FIGS. 1A-8C relate to the present invention, any dimensions shown in the figures should be taken as exemplary in nature and it is contemplated that such dimensions could be as much as 10 times larger or smeller as still remain in the scope of the present invention. Any verbiage included in these drawings is intended to be part of the present disclosure.

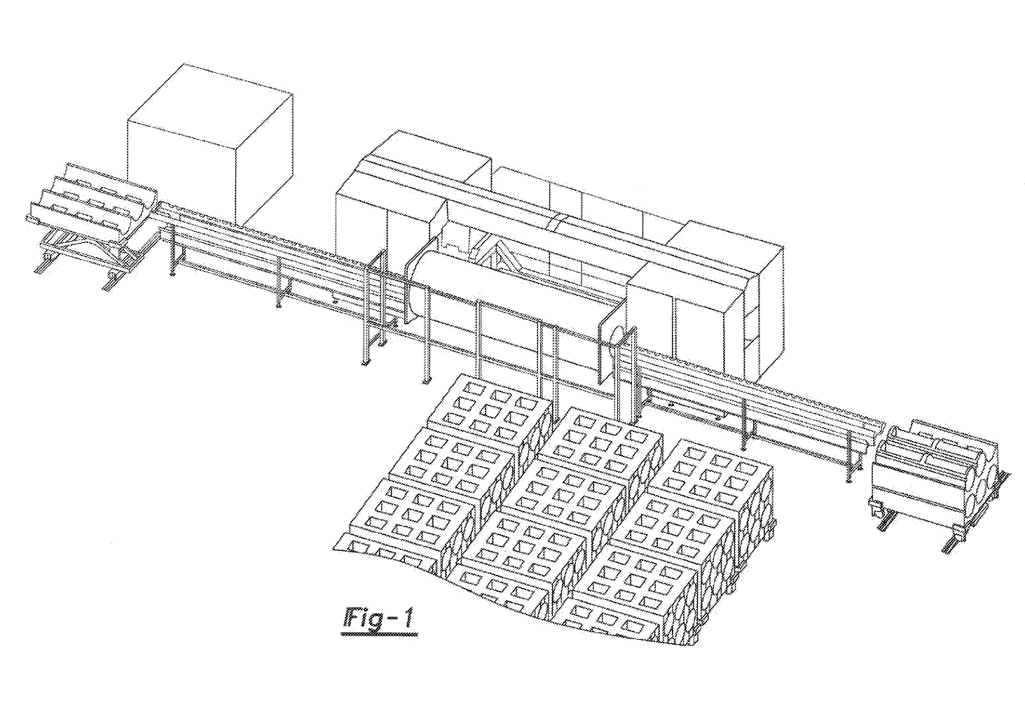

### DETAILED DESCRIPTION OF THE PREFERRED EMBODIMENT

he explanations and illustrations presented herein are intended to acquaint others skilled in the art with the invention, its principles, and its practical application. Those skilled in the art may adapt and apply the invention in its numerous forms, as may be best suited to the requirements of a particular use. Accordingly, the specific embodiments of the present invention as set forth are not intended as being exhaustive or limiting of the invention. The scope of the invention should, therefore, be determined not with reference to the above description, but should instead be determined with reference to the appended claims, along with the full scope of equivalents to which such claims are entitled. The disclosures of ail articles and references, including patent applications and publications, are incorporated by reference for all purposes. Other combinations are also possible as will be gleaned from the following claims, which are also hereby incorporated by reference into this written description.

The present invention is directed to an improved method and apparatus for material handling for a food product in a high pressure pasteurization process, The components and overall system is disclosed in further detail in the following paragraphs, in the drawings, and in the claims.

Accordingly, pursuant to one aspect of the present invention, there is contemplated a method of processing a product for processing in a high pressure pasteurization vessel in a high pressure pasteurization and processing apparatus, the method comprising one or more of the steps of: a) providing as pontoon pallet base, the base including one or more elongated basket nests; b) providing one or more elongated baskets, the baskets including one or more removable snap-in lids; d) placing one or more baskets in the one or more elongated basket nests; e) loading the product inside the elongated baskets either before or after placing step d; f) providing a pontoon pallet separator, the separator including one or more elongated basket nests on each of an opposing side, a top and bottom elongated basket nest; g) placing and nesting the separator over the elongated baskets and the pontoon pallet base: h) placing one or more baskets in the one or more top elongated basket nests; it loading the product inside the elongated baskets either before or after piecing step h; D providing a pontoon pallet cap; k) placing and nesting the cap over the elongated baskets and the pontoon pallet separator, making a pontoon pallet; l) providing a HPP machine production cell, the cell comprising: a cell loading station, a HPP machine, and a cell unloading station; m) moving the pontoon pallet to the cell loading station; n) removing the pontoon pallet cap; o) loading one of the elongated baskets onto the cell loading station; p) loading a second elongated basket onto the cell loading station; q) loading the HPP machine; r) cycling the HPP machine, processing the product in the baskets; s) repeating steps o and p; t) simultaneously loading new baskets into the HPP machine and unloading processed baskets from the HPP machine, the processes baskets moving to the cell unloading station; and u) loading the processed baskets onto a empty pontoon pallet. It is contemplated that the order of the steps disclosed above may be interchanged with each other and that certain steps can occur concurrently.

The invention may be further characterized by one or any combination of the features described herein, such as: a lifting rack system with wheels is used in place of the pontoon pallet; the pontoon pallet is placed on a cart that includes wheels; the cell loading station includes a vertically and horizontally movable lift table disposed on a track system; the cell loading station includes a basket indexing device adapted to move the basket into a pressure chamber of the HPP machine; the one or more baskets are comprised of a polymer.

Accordingly, pursuant to another aspect of the present invention, there is contemplated an apparatus 200 comprising: an elongated hollow container 201 including; one or more depressive channels 202 and a plurality of flow holes 203 disposed along its length, openings 204 at one Or both distal ends 206, and two or more tab slots 210; and one or more snap-in lid members 206 including: two or more through holes 207, two or more tabs 209, a flexible joint member 212 and one or more hand holds 208; wherein the apparatus is adapted to hold food products and is be used in a pressure chamber of the HPP machine. Optionally, the apparatus includes four spaced apart depressive channels.

Accordingly, pursuant to one aspect of the present invention, there is contemplated an apparatus comprising: a pontoon pallet base, the base including a bottom side and a top side, the top side including one or more elongated basket nests; one or more elongated hollow containers disposed in the one or more elongated basket nests, the containers including: one or more depressive channels and a plurality of flow holes disposed along its length, openings at one or both distal ends, and two or more tab slots; and one or more snap-in lid members including: two or more through holes, two or more tabs, a flexible joint member and one or more hand holds; wherein the apparatus is adapted to hold food products and is be used in a pressure chamber of the HPP machine; a pontoon pallet separator disposed above the one or more elongated hollow containers, the separator including one or more elongated basket nests on each of an opposing side, a top and bottom elongated basket nest; a second set of one or more elongated hollow containers disposed in the one or more top elongated basket nests: and a pontoon pallet cap disposed above the second set of one or more elongated hollow containers.

Illustrative embodiments of the inventive method and apparatus are shown in figures included herein.

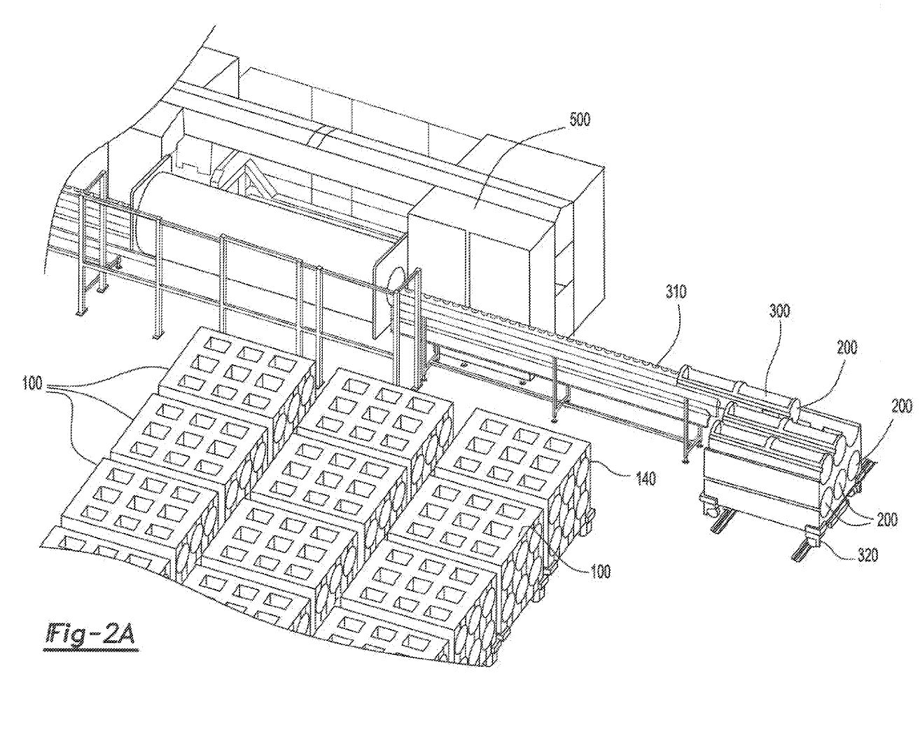

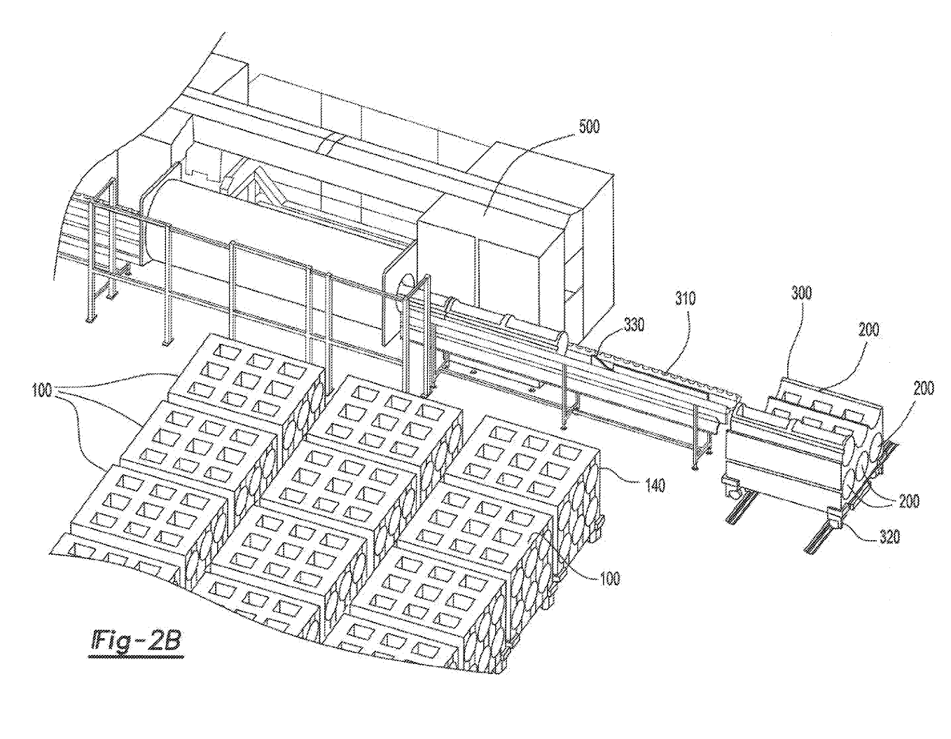

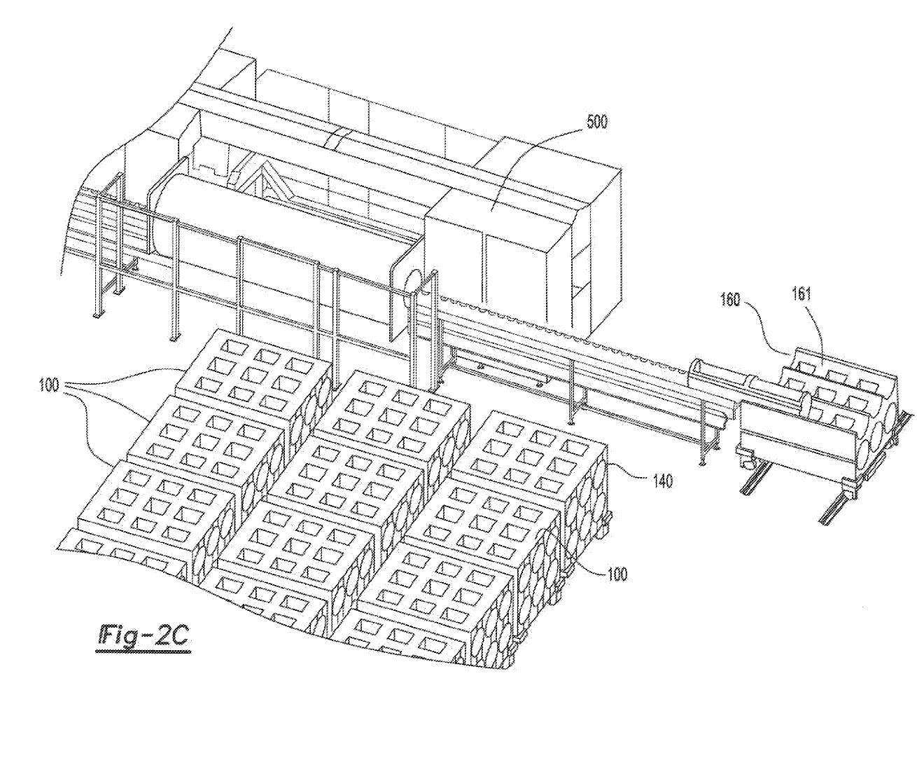

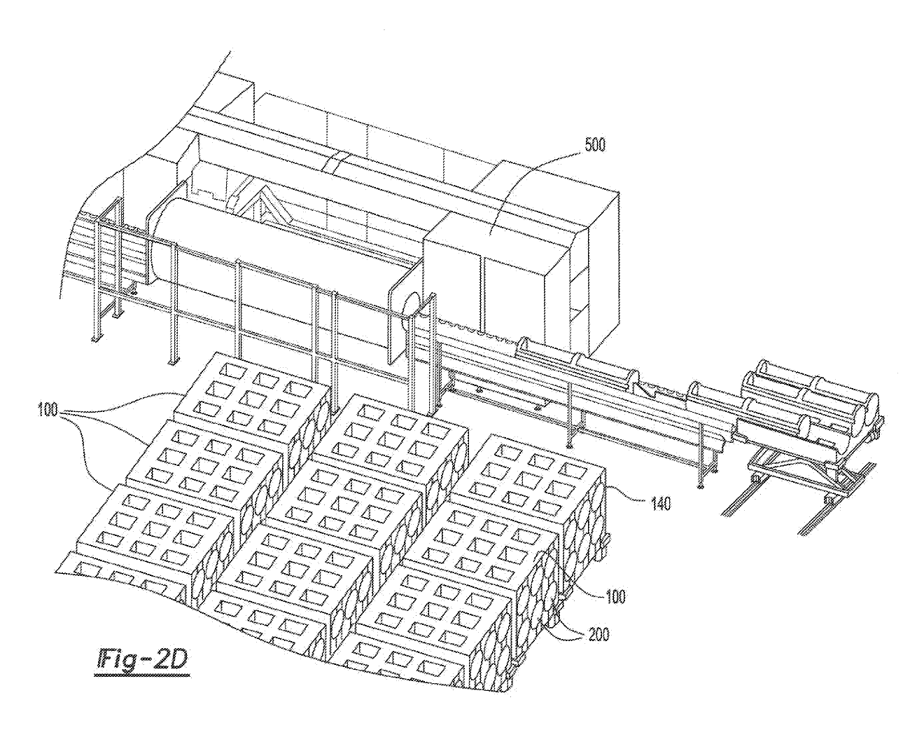

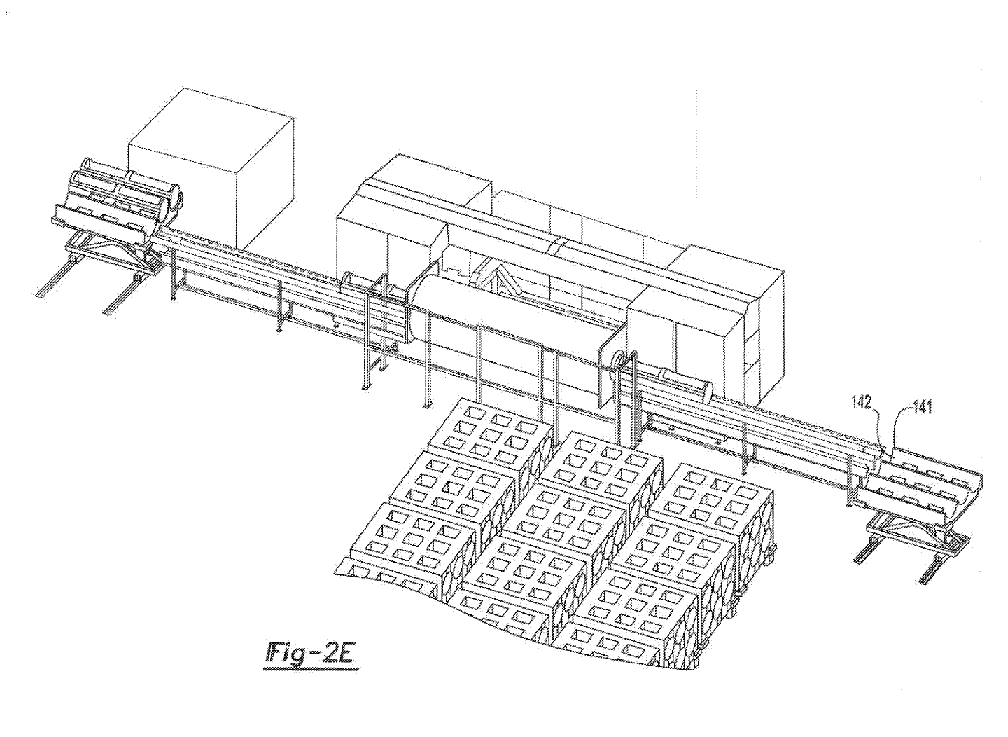

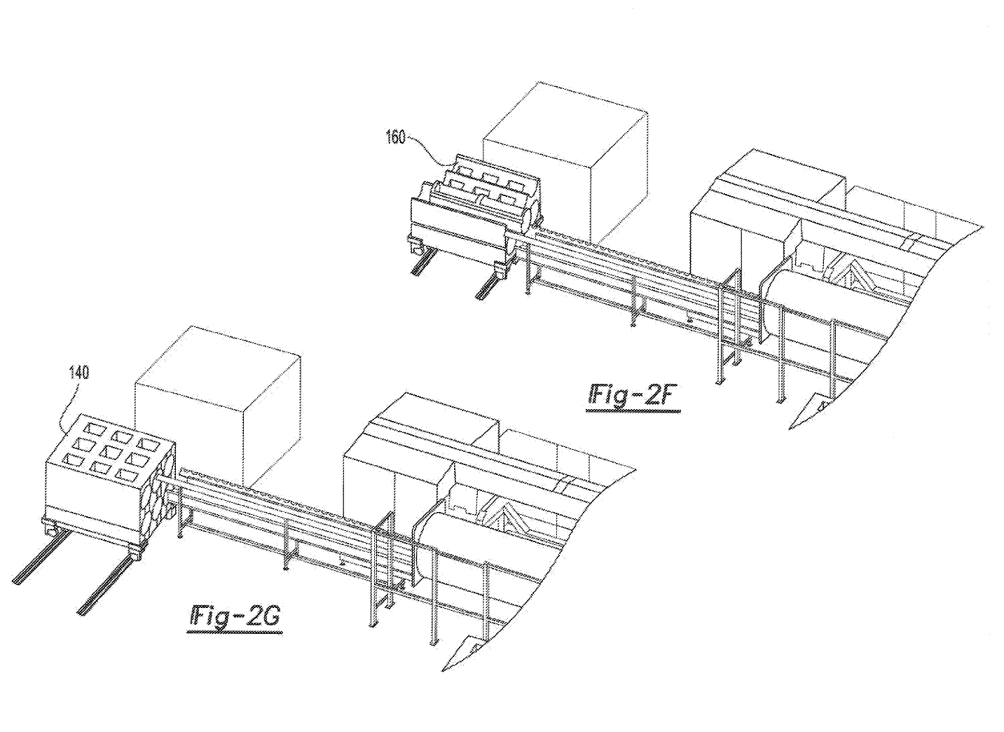

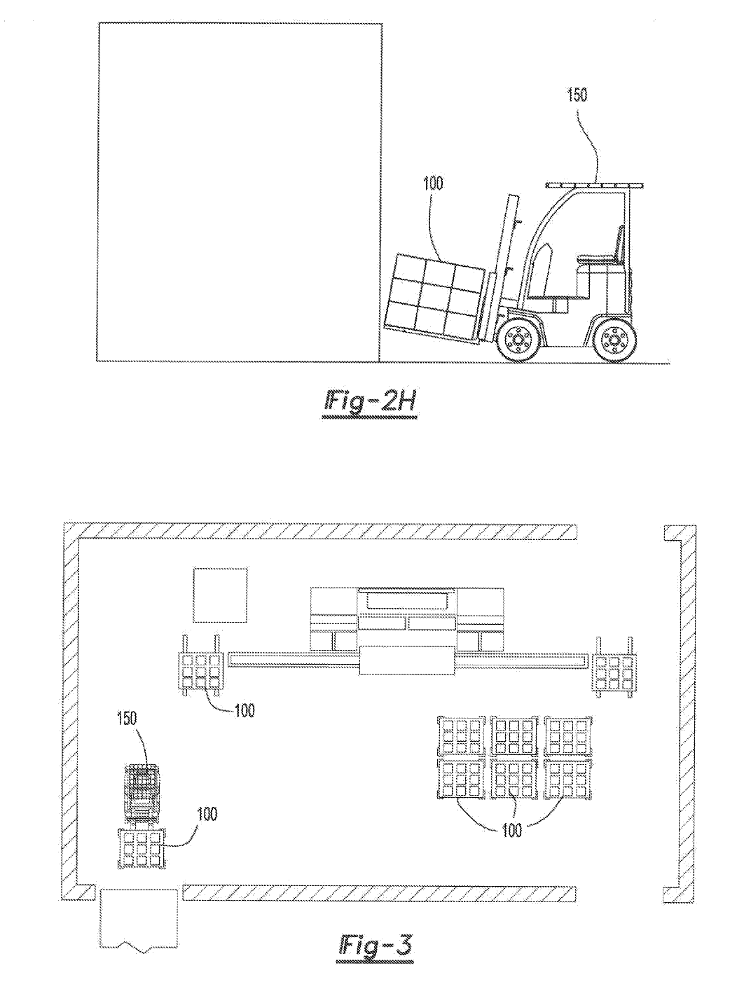

It is contemplated that in one preferred embodiment of the manufacturing process, for example as illustrated in FIGS. 2A-2I, can be generally described as: a Pontoon Pallet 100 arrives with six baskets 200 loaded. The pallet is lifted by a forklift 160 onto the pneumatic table that is on a slide rail (e.g. a vertically and horizontally movable lift table disposed on a track system 320—which may be part of a cell loading station 300) The top of the Pontoon Pallet (e.g. pontoon pallet cap 140) is removed to access the first three Baskets. The pneumatic table is lifted to the appropriate height to align the first basket with the conveyor 310 on the HPP Machine 500. The basket is then pushed onto the conveyor, the pneumatic table slides over and aligns the next basket and then that basket is also placed on the conveyor. The push arm (e.g. a basket indexing device 330) on the conveyor slides both baskets into the HPP Machine. The HPP Machine pulls into position to HPP the baskets. While the Machine is processing the first set of baskets, the pneumatic table slides over and aligns the third basket and it slides onto the conveyor, then the middle section of the Pontoon Pallet is removed. The pneumatic table lifts to the appropriate height to align the bottom row of baskets. The fourth basket slides onto the conveyor and as the HPP Machine comes back into alignment with the conveyor the push arm on the conveyor slides the next set of baskets into the HPP Machine, This action pushes the already HPP processed baskets out onto the other end of the conveyor where a gripper arm (not shown) helps pull them out of the HPP Machine. The first set of baskets is then loaded onto an empty Pontoon Pallet. The same process is then repeated for the next set of baskets.

Yet another preferred embodiment of the manufacturing process is shown and described in FIG. 3. This process begins with: 1 pontoon coming into the facility onto a pontoon cart, the 1 pontoon is taken off pontoon cart, with a forklift and placed onto a table on slide rails with pneumatic lift. The 3 table, slides on the rails and lifts into position for the first basket to be loaded onto the 4 HPP machines, conveyor system. The basket is processed and comes out the other side of the HPP machines, conveyor system. The basket is loaded onto pontoon that is placed on a table on slide rails with pneumatic lift. After pontoon is completed with six baskets loaded, a forklift comes and takes the 1 pontoon off the table on slide rails. The forklift loads the completed pontoon onto a truck for tolling.

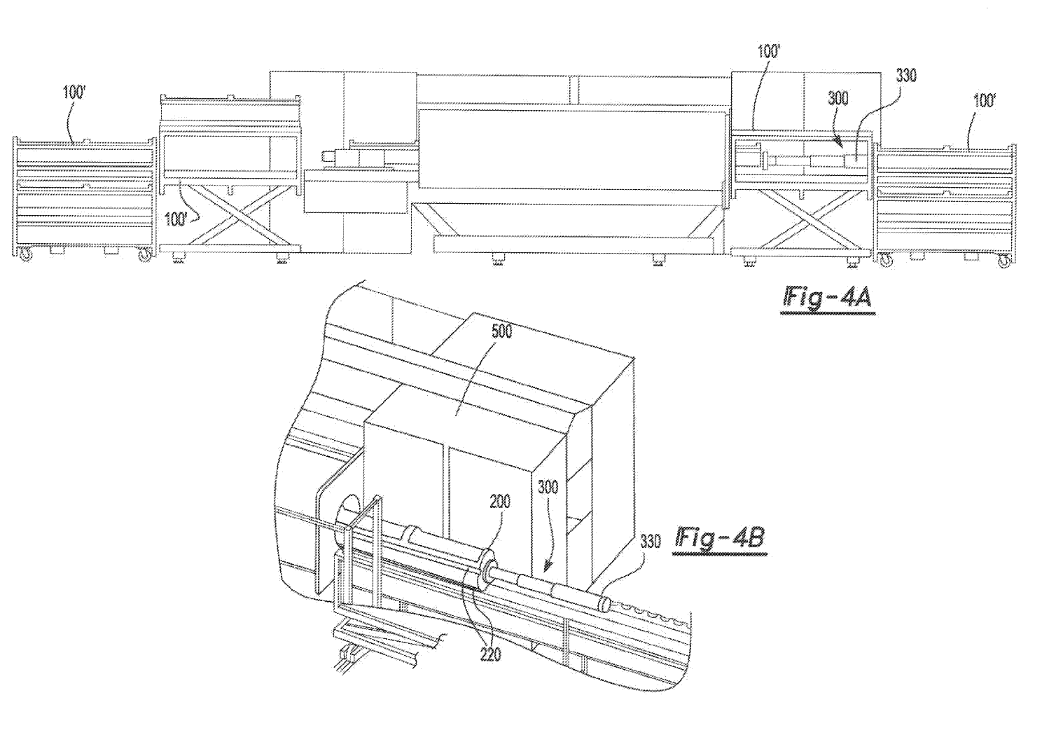

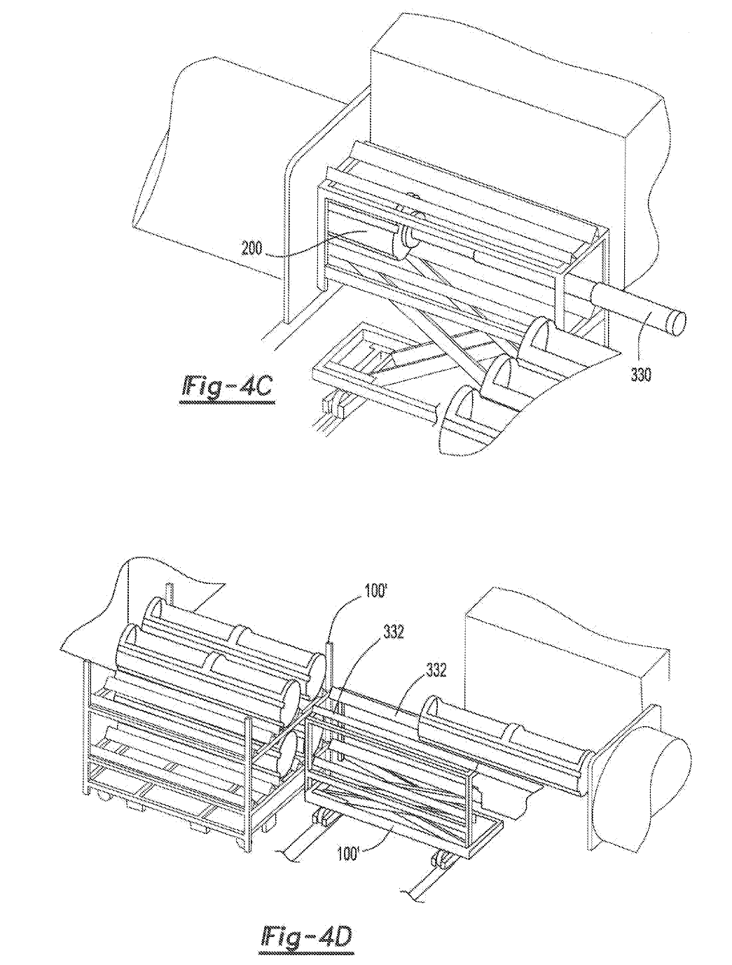

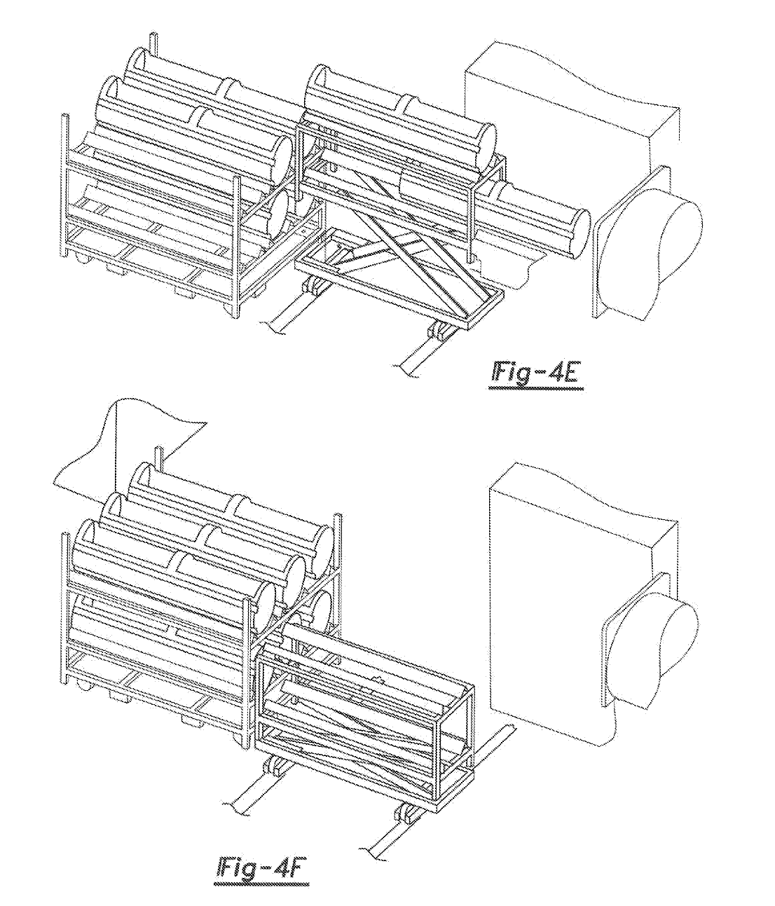

Yet another preferred embodiment of the manufacturing process is shown and described in FIGS. 4A-F. In this embodiment, the pontoon pallets and the lift table disposed on a track system are replaced with a lifting rack system 100′ (one on a track system and one as a storage pallet. The basket indexing device 330′ is also in the form of a pusher arm. Of note, the lifting racking system may have charm& members 332 that are adapted to mate with the one or more basket channels 220.

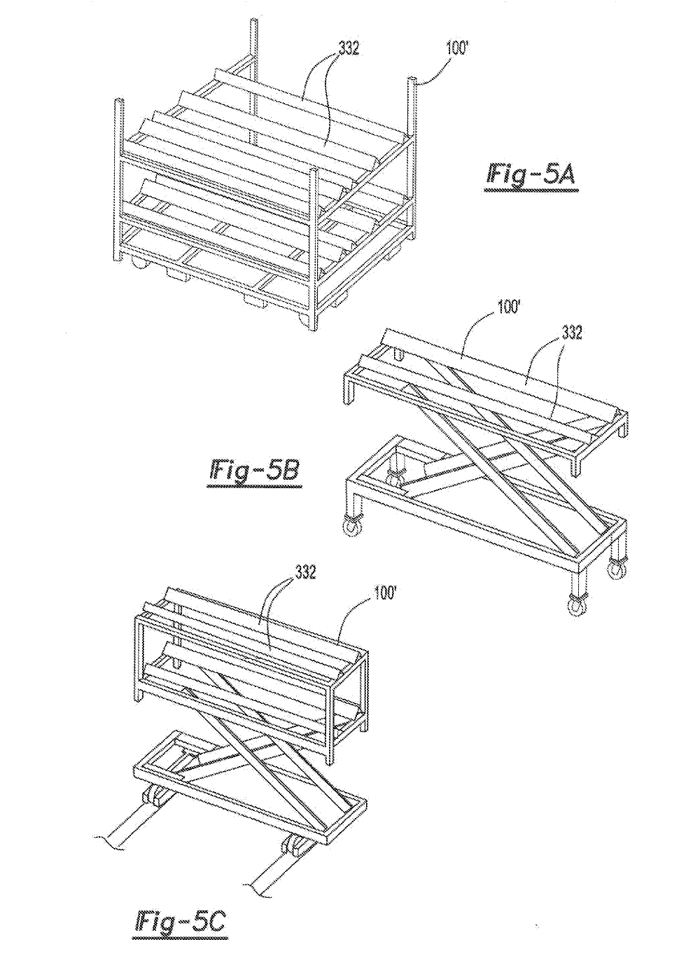

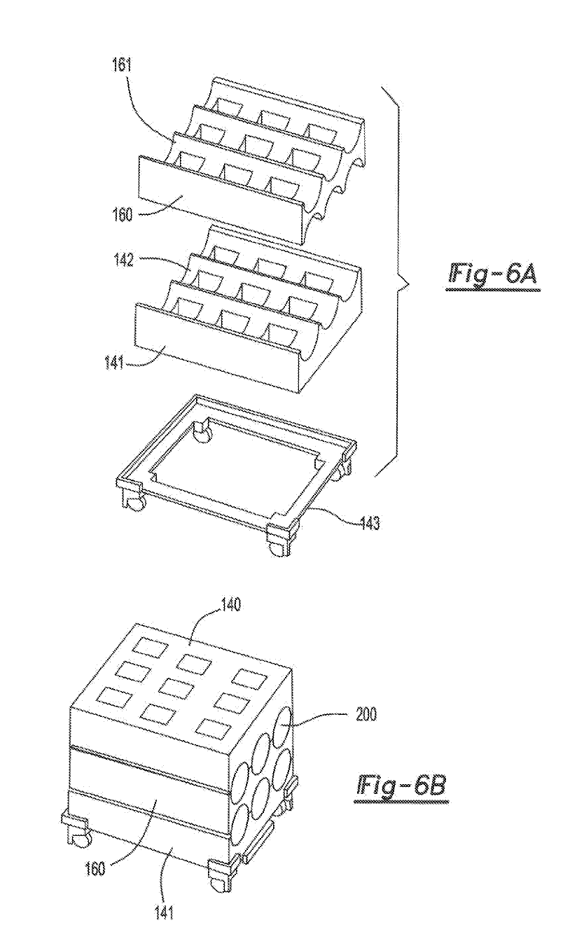

Disclosed in FIGS. 5A-C and 6A-B are illustrative embodiments of both the pontoon pallet 100 and the lifting rack system 100′. All dimensions are for example only and should not be considered as limiting. Shown are a separator 100, nesting baskets 161, a pontoon pallet base 141 with nesting baskets 142. The base 141 can also be sued as the pontoon pallet cap 140. The assembly can be placed on a pontoon pallet cart 143. Lifting rack systems can be used to move and adjust the height of the articles of the invention. A variety of such carts may be utilized

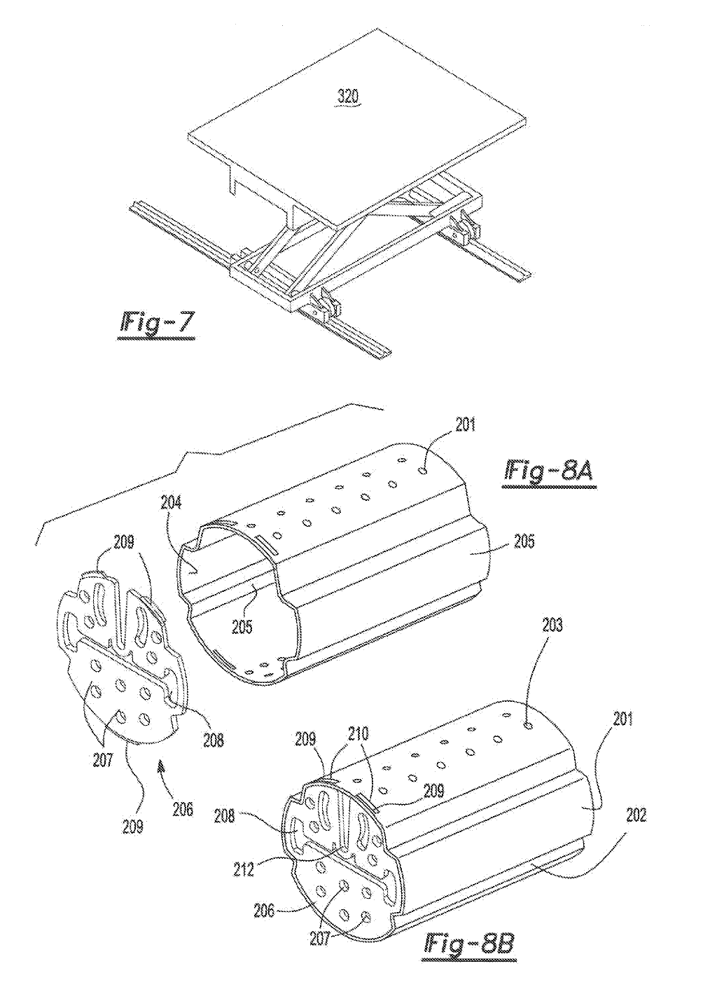

Disclosed in FIG. 7 is an exemplary vertically and horizontally movable lift table disposed on a track system 320.

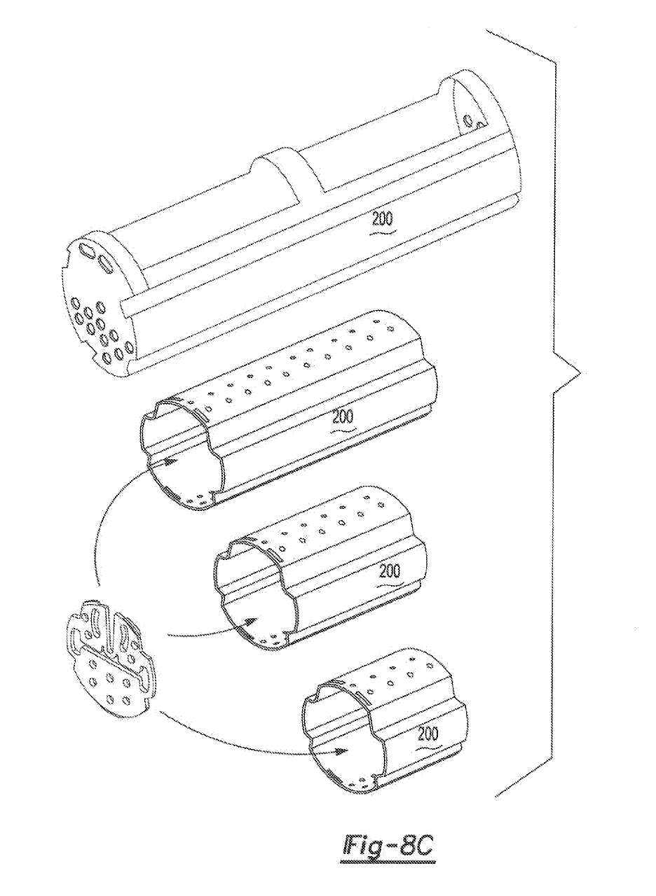

Disclosed in FIGS. 8A-C, are exemplary embodiments of the basket 200.

Disclosed are further embodiments of the components and methods related to the present invention. The pontoon pallets useful in the invention may have the same width as a standard pallet and may have as length to fit the baskets, which may be longer than a standard pallet. The advantages of the pontoon pallet include easy loading and unloading, light weight allowing for shipping more product and less packaging material, are safe and secure while maximizing space. They can be stacked, loaded onto castor platforms and/or transported using a common forklift with pockets on all four sides. The use of power lift tables with rails in combination with the Pontoon pallets products can easily and efficiently be loaded for shipment. The baskets can be loaded and moved from location to location and reoriented from a horizontal to a vertical position using robots. A variety of carts, lifting carts and lift trays can be used in this process. These can be adapted to a user's process.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

Any numerical values recited in the above application include all values from the lower value to the upper value in increments of one unit provided that there is a separation of at least 2 units between any lower value and any higher value. As an example, if it is stated that the amount of a component or a value of a process variable such as, for example, temperature, pressure, time and the like is, for example, from 1 to 90, preferably from 20 to 80, more preferably from 30 to 70, it is intended that values such as 15 to 85, 22 to 68, 43 to 51, 30 to 32 etc. are expressly enumerated this specification. For values which are less than one, one unit is considered to 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The disclosures of all articles and references, including patent applications and publications, are incorporated by reference for all purposes.

The term “consisting essentially of” to describe a combination shall include the elements, ingredients, components or steps identified, and such other elements ingredients, components or steps that do not materially affect the basic and novel characteristics of the combination.

The use of the terms “comprising” or “including” to describe combinations of elements, ingredients, components or steps herein also contemplates embodiments that consist essentially of the elements, ingredients, components or steps.

Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps. All references herein to elements or metals belonging to a certain Group refer to the Periodic Table of the Elements published and copyrighted by CRC Press, Inc., 1989. Any reference to the Group or Groups shall be to the Group or Groups as reflected in this Periodic Table of the Elements using the IUPAC system for numbering groups.

1. A method comprising:
a) placing one or more elongated baskets, the baskets including one or more removable snap-in lids in one or more elongated basket nests of a pontoon pallet base;
b) placing and nesting a pontoon pallet separator, the separator including one or more elongated basket nests on each of two opposing sides, over the elongated baskets and the pontoon pallet base;
c) placing one or more baskets in the one or more top elongated basket nests on the separator;
d) loading product inside the elongated baskets either before or after the placing steps;
e) placing a pontoon pallet cap and nesting the cap over the elongated baskets and the pontoon pallet separator, making a pontoon pallet;
f) moving the pontoon pallet to a cell loading station;
g) removing the pontoon pallet cap;
h) sequentially loading the elongated baskets onto the cell loading station;
i) sequentially loading the elongated baskets into a high pressure pasteurization machine and processing the product in the baskets;
j) unloading processed baskets from the high pressure pasteurization machine and moving the processes baskets to a cell unloading station; and
k) loading the processed baskets onto an empty pontoon pallet.

2. A method according to claim 1 which comprises simultaneously loading new baskets into the high pressure pasteurization machine and unloading processed baskets from the high pressure pasteurization machine, the processed baskets moving to the cell unloading station.

3. The method according to claim 1 wherein a lifting rack system with wheels is used in place of the pontoon pallet.

4. The method according to claim 1, wherein the pontoon pallet is placed on a cart that includes wheels.

5. The method according to claim 1, wherein the cell loading station includes a vertically and horizontally movable lift table disposed on a track system.

6. The method according to claim 1, wherein the cell loading station includes a basket indexing device adapted to move the basket into a pressure chamber of the HPP machine.

7. The method according to claim 1, wherein the one or more baskets are comprised of a polymer.

8. An apparatus comprising:
an elongated hollow container including: one or more depressive channels and a plurality of flow holes disposed along its length, openings at one or both distal ends, and two or more tab slots; and
one or more snap-in lid members including: two or more through holes, two or more tabs, a flexible joint member and one or more hand holds;
wherein the apparatus is adapted to hold food products and is be used in a pressure chamber of the HPP machine.

9. The apparatus according to claim 8, further comprising four spaced apart depressive channels.

10. An apparatus comprising:
a pontoon pallet base, the base including a bottom side and a top side, the top side including one or more elongated basket nests;
one or more elongated hollow containers disposed in the one or more elongated basket nests, the containers including:
one or more depressive channels and a plurality of flow holes disposed along its length, openings at one or both distal ends, and two or more tab slots; and
one or more snap-in lid members including: two or more through holes, two or more tabs, a flexible joint member and one or more hand holds;
wherein the apparatus is adapted to hold food products and is be used in a pressure chamber of the HPP machine;
a pontoon pallet separator disposed above the one or more elongated hollow containers, the separator including one or more elongated basket nests on each of an opposing side, a top and bottom elongated basket nest;
a second set of one or more elongated hollow containers disposed in the one or more top elongated basket nests; and
a pontoon pallet cap disposed above the second set of one or more elongated hollow containers.

11. A method of processing a product for processing in a high pressure pasteurization vessel in a high pressure pasteurization and processing apparatus, the method:
a) providing a pontoon pallet base, the base including one or more elongated basket nests;
b) providing one or more elongated baskets, the baskets including one or more removable snap-in lids;
d) placing one or more baskets in the one or more elongated basket nests;
e) loading the product inside the elongated baskets either before or after placing step d;
f) providing a pontoon pallet separator, the separator including one or more elongated basket nests on each of an opposing side, a top and bottom elongated basket nest;
g) placing and nesting the separator over the elongated baskets and the pontoon pallet base;
h) placing one or more baskets in the one or more top elongated basket nests;
i) loading the product inside the elongated baskets either before or after placing step h;
j) providing a pontoon pallet cap;
k) placing and nesting the cap over the elongated baskets and the pontoon pallet separator, making a pontoon pallet.
l) providing a HPP machine production cell, the cell comprising: a cell loading station, a HPP machine, and a cell unloading station;
m) moving the pontoon pallet to the cell loading station;
n) removing the pontoon pallet cap;
o) loading one of the elongated baskets onto the cell loading station;
p) loading a second elongated basket onto the cell loading station;
q) loading the HPP machine;
r) cycling the HPP machine, processing the product in the baskets;
s) repeating steps o and p;
t) simultaneously loading new baskets into the HPP machine and unloading processed baskets from the HPP machine, the processes baskets moving to the cell unloading station; and
u) loading the processed baskets onto a empty pontoon pallet.
